(19) United States
(12) Patent Application Publication
(10) Pub. No.: US 2008/0002964 A1
(43) Pub. Date: Jan. 3, 2008

(54) METHOD AND SYSTEM FOR A DIGITAL READING GLASS

(75) Inventor: DAVID KEITH EDWARDS, ELK GROVE VILLAGE, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/428,124

(22) Filed: Jun. 30, 2006

(51) Int. Cl. G03B 13/02

(52) U.S. Cl. 396/374

(57) ABSTRACT

A method (50) and system for a digital reading glass (10) in a camera phone can include, a display (22), and a processor (11) coupled to the camera (14) and display. In addition, the digital reading glass can further include a light source (16 or 18). The light source can be adjustable as to maintain a predetermined brightness level. The camera phone can further include a dedicated button (26) for entering the magnifying glass mode. The processor can be programmed to selectively operate during a magnifying glass mode to have a substantially constant level of magnification regardless of focal length. The processor can also be programmed to provide image stabilization (58) during the magnifying glass mode and track image registrations (60) in an X, Y and Z direction. The processor can also be programmed to use motion detection for scrolling a previously captured image.

### FIELD

This invention relates generally to digital cameras, and more particularly to a reading glass function used in conjunction with digital cameras.

### BACKGROUND

There have been several attempts at adaptations to an embedded digital camera to make its performance suitable for use as a magnifying glass. So far, such attempts have not been known to exist for digital camera phones, yet such a device would be useful for users with poor eyesight for reading smaller text or the elderly or for any user who normally keeps reading glasses or a magnifying glass handy.

Prior related products include digital photographic equipment that primarily includes wiring for stationary use. Some are more portable but they typically require carrying a separate special device. Furthermore, such existing digital magnifying glass solutions typically cost over $300 and often closer to $900. Existing solutions fail to use existing components in a device that a user might already carry with them (such as a cell phone). Nonetheless, existing pocket sized camera phones & small digital cameras do not have satisfactory performance when used for real-time magnification, especially for reading text in real time. Existing cameras do not have a continuous light source, close focus by default, appropriate magnification by default, or appropriate types of image stabilization among other features that can make a digital camera useful and ideal as a magnifying glass tool.

### SUMMARY

Embodiments in accordance with the present invention provide a digital magnifying glass tool or function used in an embedded camera device such as a portable camera phone. Such a device enables the magnification and reading of small printed matter such as text or images in real time. Users who normally have a cell phone at hand or other users who need to have a magnified look at small things in their daily work or lives can now conveniently have such a tool without additional hardware beyond a convenient device they would personally carry with them anyway.

In a first embodiment of the present invention, a digital reading glass in a camera phone can include a camera integrated with a phone, a display, and a processor coupled to the camera and display. A camera integrated with a phone means a camera housed in the same housing with a portable communication device. In addition, the digital reading glass can further include a light source. The light source can be adjustable as to maintain a predetermined brightness level. The display can be on a front side of the camera phone and the camera can be on a back side of the camera phone. The camera phone can further include a dedicated button for entering a magnifying glass mode that would provide magnification at a substantially constant level and optionally other features as can be designed as a default or set by a user. The processor can be programmed to selectively operate during the magnifying glass mode to have a substantially constant level of magnification regardless of focal length. In photography as in the embodiments herein, the focal length can be the distance from the center of the lens to the image of an object at infinity. The focal length is also known as the distance from the lens to a film plane or sensor that focuses light at infinity or the distance from a camera lens's focal point to its CCD imaging chips with the lens focus set to infinity. The processor can also be programmed to provide a fisheye lens image effect where edges of a field of view are visible and a center area is most magnified. The processor can also be programmed to provide image stabilization during the magnifying glass mode. The processor can be programmed to track image registrations in an X direction where image registration changes in the X direction causes the display to be updated frequently, track image registrations in an Y direction where image registration changes in the Y direction causes a display routine to attempt to keep lines of text where they were in a previous frame, or track image registration in a Z direction where image registration changes in the Z direction causes the adjustment of magnification to maintain a substantially constant text size. The processor can also be programmed to use motion detection for scrolling a previously captured image. The processor can be further programmed to perform optical character recognition when displaying text. In this regard, the camera can further include a speaker and the processor can be further programmed to synthesize text to speech on text recognized using optical character recognition to provide an audible output.

In a second embodiment of the present invention, a system of providing a magnifying glass function in a camera phone can include a camera, a transceiver coupled to the camera, a display, an adjustable light source, and a processor coupled to the camera, display, and light source. The processor can be programmed to selectively operate during a magnifying glass mode to have a substantially constant level of magnification regardless of focal length and adjust the light source to maintain a predetermined brightness level. The processor can also be programmed to provide image stabilization during the magnifying glass mode. The processor can be programmed to track image registrations in an X direction where image registration changes in the X direction causes the display to be updated frequently, track image registrations in an Y direction where image registration changes in the Y direction causes a display routine to attempt to keep lines of text where they were in a previous frame, and track image registration in a Z direction where image registration changes in the Z direction causes the adjustment of magnification to maintain a substantially constant text size.

In a third embodiment of the present invention, a method of providing a digital reading glass function using a camera phone can include the steps of obtaining an series of images with a camera from a camera phone and selectively display the series of images during a magnifying glass mode in a manner having a substantially constant level of magnification notwithstanding variations in focal length. The method can further include the step of modifying a light source intensity in order to maintain a predetermined brightness level or stabilizing the series of images during the magnifying glass mode. The method can further optionally include the steps of tracking image registrations in an X direction where image registration changes in the X direction causes the display to be updated frequently, tracking image registrations in an Y direction where image registration changes in the Y direction causes a display routine to attempt to keep lines of text where they were in a previous frame, and tracking image registrations in a Z direction where image registration changes in the Z direction causes the adjustment of magnification to maintain a substantially constant text size.

Other embodiments, when configured in accordance with the inventive arrangements disclosed herein, can include a system for performing and a machine readable storage for causing a machine to perform the various processes and methods disclosed herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

### BRIEF DESCRIPTION OF THE DRAWINGS

FIG. 1 is an illustration of an embedded camera such as a camera phone in accordance with an embodiment of the present invention.

FIG. 2 is a front view of the camera phone of FIG. 1 in accordance with an embodiment of the present invention.

FIG. 3 is an illustration of the camera phone of FIG. 1 operating as a magnifying glass in accordance with an embodiment of the present invention.

FIG. 4 is an illustration of the camera phone of FIG. 3 maintaining a substantially constant magnification level regardless of the focal length in accordance with an embodiment of the present invention.

FIG. 5 is an illustration of the camera phone of FIG. 1 depicting a fisheye lens effect in accordance with an embodiment of the present invention.

FIG. 6 is a flow chart illustrating a method of providing a digital reading glass function using a camera phone in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

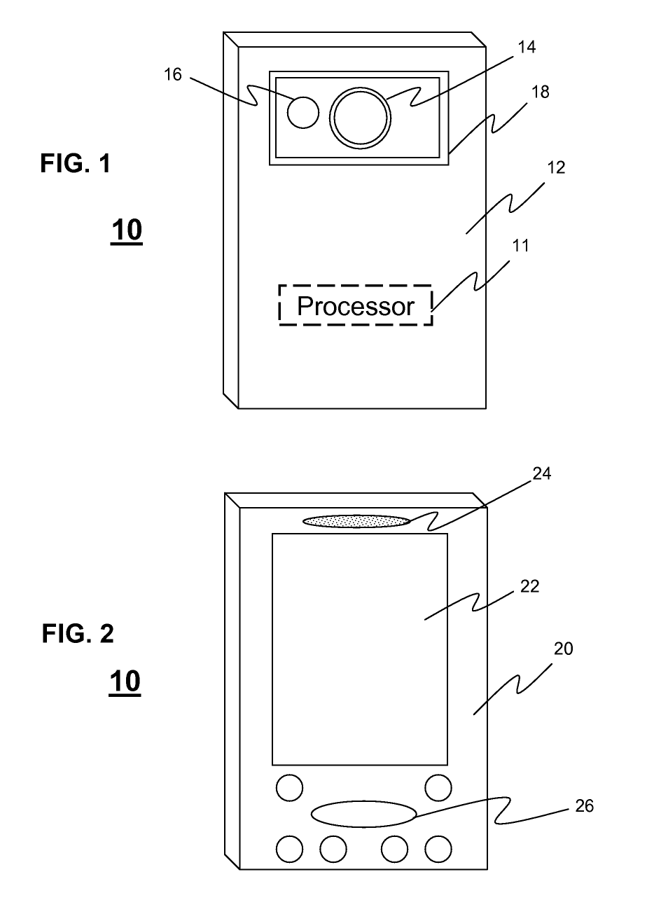

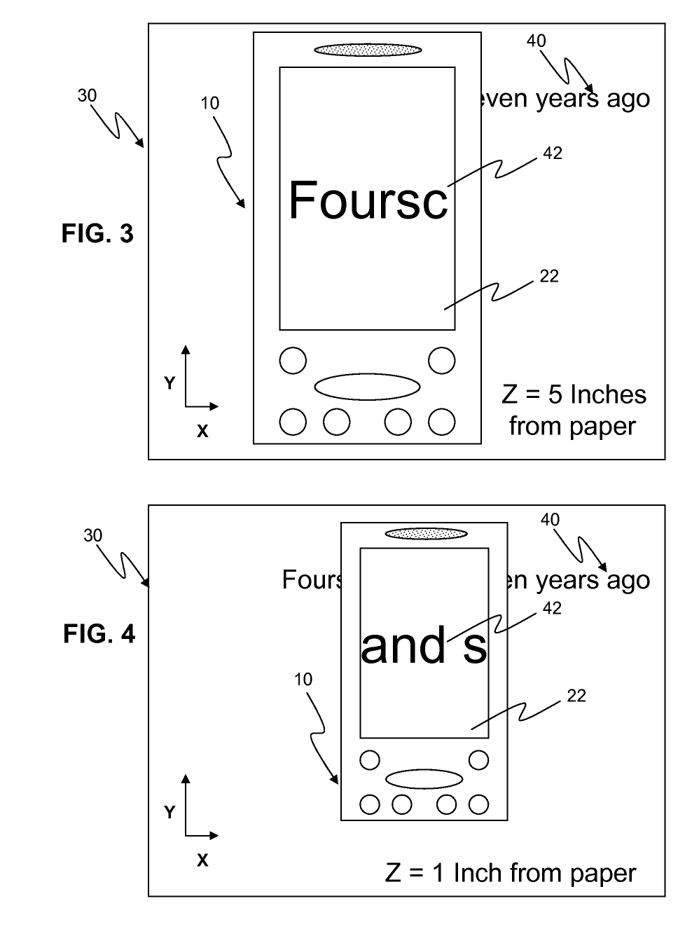

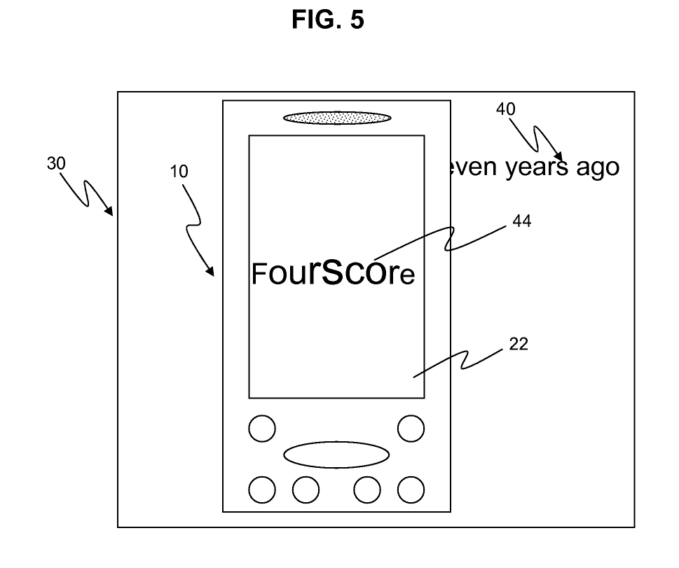

Referring to FIGS. 1 and 2, a digital reading glass 10 in the form of a camera phone can include a camera 14 integrated with a phone, a display 22, and a processor 11 coupled to the camera and display. In addition, the digital reading glass 10 can further include a light source 16 or 18. The light source can be adjustable as to maintain a predetermined brightness level. The light source can be one or more light emitting diodes (LEDs) or a light pipe or other form of light such as reused light from a display backlight. The display 22 can be on a front side 20 of the camera phone and the camera 14 can be on a back side 12 of the camera phone. The camera phone can further include a dedicated button 26 for entering the magnifying glass mode. The button 26 can provide easy-access to enable the device 10 to instantly enter ‘magnifying glass’ mode. The processor 11 can be programmed to selectively operate during a magnifying glass mode to have a substantially constant level of magnification regardless of focal length as can be seen in FIGS. 3 and 4. The processor 11 can also be programmed to provide a fisheye lens image effect where edges of a field of view are visible and a center area is most magnified as illustrated in FIG. 5.

The processor 11 can also be programmed to provide image stabilization during the magnifying glass mode. The processor 11 can be programmed to track image registrations in an X direction where image registration changes in the X direction causes the display to be updated frequently, track image registrations in an Y direction where image registration changes in the Y direction causes a display routine to attempt to keep lines of text where they were in a previous frame, or track image registration in a Z direction where image registration changes in the Z direction causes the adjustment of magnification to maintain a substantially constant text size. The processor 11 can also be programmed to use motion detection for scrolling a previously captured image. The processor 11 can be further programmed to perform optical character recognition when displaying text. In this regard, the camera phone or digital reading glass can further include a speaker 24 and the processor 11 can be further programmed to synthesize text to speech on text recognized using optical character recognition to provide an audible output.

Note, the use of motion detection (which can be derived from a “live image” the camera or sensor sees, which is not necessarily the same as the “stored image” the user sees) can be used to scroll through a previously captured image (or the image that is actually being displayed to the user). This can result in a more stable image than by constantly refreshing the display with the “live” image. Stabilization can mean moving at a smooth rate (i.e. slow & steady), not just stationary. Further note, the X and Y axis referred to herein can be different depending on user's preferred orientation (holding the device vertical or sideways). The X and Y axis shown in FIGS. 2-5 are in a vertical orientation. Also note that image stabilization can be achieved in number of ways. In a first method, a newly captured image can be adjusted to stay aligned with a previous display. In a second method, a previously captured image can be reused where a relevant portion of the previously captured image is displayed. Further note that the first method (frequent capture of new images) is particularly useful when the camera motion is fast and the second method (slight adjustments of previously captured image) might be better suited when the camera motion is slow.

The embodiments herein can involve software and hardware adaptations or optimizations, to provide satisfactory performance for magnifying and reading small text (or images, such as a map) in real time. Software optimization can particularly impact user interactions and methods of image stabilization. During operation, when the magnifying glass mode is pressed for example, the optics and software can immediately set to a user's preferences for magnifying mode with a default focal length/macro focus, brightness level, default display magnification, and X or Y axis image smoothing. For screens which are wider on the vertical axis, the device can be held sideways for a wide (text-line oriented) screen. As can be seen in FIGS. 3 and 4, the digital reading glass 10 can maintain the same magnification level for the text 40 from the paper 30 being viewed by the camera and displayed as text 42 on display 22 whether the digital reading glass 10 is 5 inches away from the paper 30 as in FIG. 3 or 1 inch away from the paper 30 as in FIG. 4. The digital magnifying glass 10 is panning across text 40 that states “Fourscore and seven years ago”.

Note that as a typical camera is moved farther away from a subject, the magnification decreases (which is opposite a magnifying glass). But with a sufficiently high screen resolution, a camera device could (optionally) be programmed to maintain a constant level of magnification and optionally at a user's preferred level of magnification as a default) at all distances, so that moving the screen closer to the eye would provide a wider field of view (i.e., an “effectively larger” screen, without requiring a larger device. Known reading products using cameras do not appear to behave in this manner.

Other options may also become possible at higher display resolutions, such as a fisheye lens image processing effect as shown in FIG. 5 where the page edges stay visible, but the center is most magnified. In this instance, when viewing and displaying the text 44 from the text 40, the word “Fourscore” would tend to have larger letters in the middle and smaller letters at the ends. This assumes that the term “Fourscore” is magnified to the extent that it spans across the X axis of the display. Conversely, the user can set a high level of magnification and still prefer to hold the device farther from the subject (for reading signage, etc.) in which case the large magnification at a distance would cause more image jitter (due to normal or pathological hand tremor), and a small field of view which might require additional kinds of image stabilization.

Some conventional methods of still-image stabilization may be useful when the phone is held relatively still (where the device can sense motion from the live image), however, the display must also be able to smooth the jitter of an image that the user is intentionally moving, because the user may be “scrolling” the handset across the page (or making a similar gesture a greater distance from the subject to control an analogous “panning” effect) where the result should be a fairly steady/smooth image. When “scrolling”, or when “panning” from a distance, the display must scale the rate of motion appropriately so the text is easy to read.

An alternative method to stabilize the changing image the user sees can include front-end image processing that monitors a scene at all times and gauges how fast a camera view is moving (there are several methods for this, such as calculating discrete derivatives). When moving fast, the screen can update the images in real time (this is used when locating the desired text). But as the view in frame slows and is held nearly steady, the frame rate as displayed slows down to allow the camera time to seek a best focus and capture a still image at high resolution and freeze that image on screen until the scene is moved substantially. Note, some digital camera displays show only a rough image until a shutter is pressed, but do not automatically adjust the display based on view ‘velocity’.

Some assumptions can also be made with respect to axes. Considering the X axis as the reading direction of text on a page (horizontal), then the Y axis can be up and down the page, and the Z axis can be the elevation above the page or distance from the page (the focal length).

When an image is captured and immediately displayed, the position of the image in the display corresponds to the position of the scene in the world, and the image is said to be “in registration”. If the camera then changes position slightly, while still displaying the unchanged image, it is “out of registration”. A displayed image can be kept close to registration in real time either by capturing a new image, or mathematically altering the existing image (e.g. by scrolling it appropriately).

The image size of a captured image can easily be larger than the display can show at full resolution. In a text magnification application, the image is not scaled to display the entire picture at reduced resolution, rather, only part of the image is displayed (initially the center), at the user's preferred magnification, and the rest of the image is logically off the edge of the display. Experiments with a 5 Megapixel digital camera show that resolution is sufficient to capture an entire magazine page in one snapshot at a resolution that is comfortably readable when magnified. This indicates that text can be captured quite infrequently if the device is held far enough away from the page. The limitations of ordinary camera user interfaces make reading such an image impractically difficult though and button pressing is typically an unsatisfactory way to scroll through an image.

In embodiments as contemplated herein, as the user moves the handset, the stored image can be scrolled accordingly, keeping it in registration with the actual subject as well as possible. This can be simpler for text at a range of several inches, but it may be possible at a long distance with some modifications. As the edge of the stored image is reached (or registration is slipping too much), a new image can be captured and displayed in registration with the previous image.

A displayed image can be preferentially stabilized in directions that are a distraction to reading text, that is, the Y and Z directions. If the image registration changes in the X direction, the display can be updated frequently, if it changes in the Y direction, the display software can make some attempt to keep the lines of text where they were in the previous frame, or to at least move them smoothly, rather than jitter with the user's hand. Similarly, if the Z distance is changing, the magnification can be adjusted slightly to keep the text the same size (or to adjust it smoothly rather than jitter with the user's hand). These types of image jitter effects can easily be demonstrated with a normal digital camera.

Existing pocket sized camera phones & small digital cameras do not have satisfactory performance when used for real-time magnification, especially for reading text in real time. Existing cameras do not have a continuous light source, close focus by default, appropriate magnification by default, or appropriate types of image stabilization for example. A device as contemplated herein can independently derive the magnification [and the focal length] needed, by tracking the scale & motion of features in the image, and also seeking out the focus, independent of each other. Note, the display magnification can be kept very roughly in scale by using a fixed ratio method, but it can also be corrected independently by tracking some features in the image (the outer edge of a letter, or any closed figure for one example), without regard to any previous ratio.

Other embodiments can determine an appropriate display magnification independent of the focal length. Existing cameras seem to be absolutely dependent on a fixed relationship to the focal length (a scale factor that must not change, and must be manually set by the user initially). Instead, embodiments herein can takes a magnification ‘preference’ from a user as an input, but automatically determine the scale factor needed to achieve that result as the camera is moved. This approach could even apply different magnification to different parts of the same image if necessary, for example if text is being viewed from a slightly oblique angle. A camera using an embodiment herein can continuously re-scale or pan across an image that was previously captured using only a CCD input to derive the motion of the camera, and not necessarily by continually capturing new “live” images.

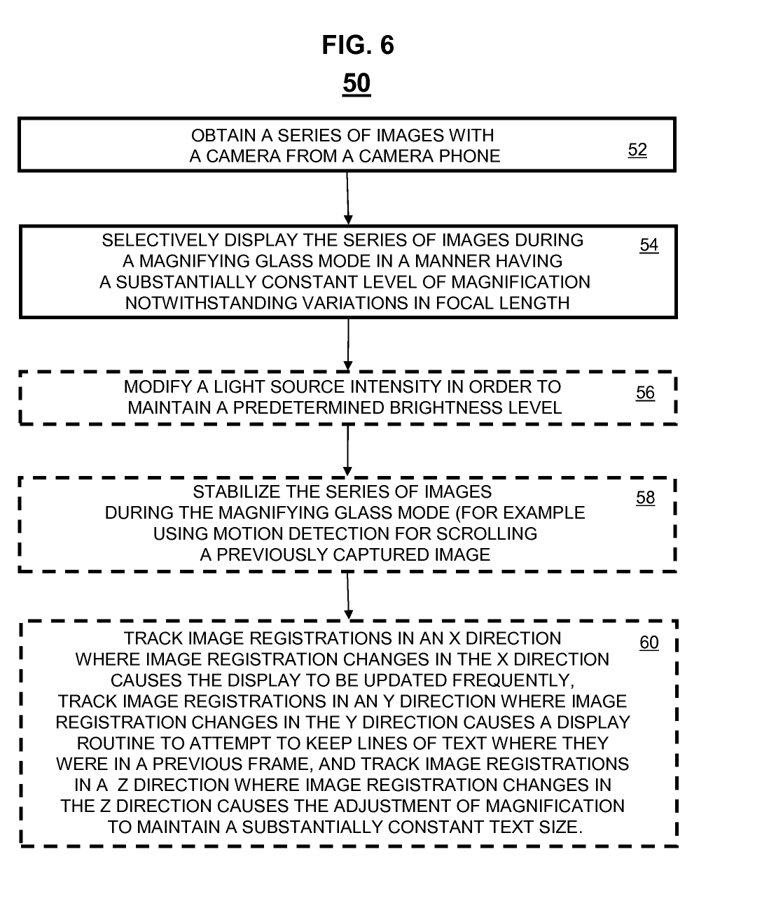

Referring to FIG. 6, a flow chart illustrating a method 50 of providing a digital reading glass function using a camera phone can include the step 52 of obtaining a series of images with a camera from a camera phone and selectively display the series of images during a magnifying glass mode in a manner having a substantially constant level of magnification notwithstanding variations in focal length at step 54. The method 50 can further include the step 56 of modifying a light source intensity in order to maintain a predetermined brightness level or the step 58 of stabilizing the series of images during the magnifying glass mode. The method 50 can further optionally include the step 60 of tracking image registrations in an X direction where image registration changes in the X direction causes the display to be updated frequently, tracking image registrations in an Y direction where image registration changes in the Y direction causes a display routine to attempt to keep lines of text where they were in a previous frame, and tracking image registrations in a Z direction where image registration changes in the Z direction causes the adjustment of magnification to maintain a substantially constant text size.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A digital reading glass in a camera phone, comprising:
a camera integrated with a phone;
a display; and
a processor coupled to the camera and display, wherein the processor is programmed to:
selectively operate during a magnifying glass mode to have a substantially constant level of magnification regardless of focal length.

2. The digital reading glass of claim 1, wherein the digital reading glass further comprises a light source.

3. The digital reading glass of claim 2, wherein the light source is adjustable as to maintain a predetermined brightness level.

4. The digital reading glass of claim 1, wherein the processor is programmed to provide a fisheye lens image effect where edges of a field of view are visible and a center area is most magnified.

5. The digital reading glass of claim 1, wherein the processor is programmed to provide image stabilization during the magnifying glass mode.

6. The digital reading glass of claim 1, wherein the processor is programmed to track an image registration in an X direction, a Y direction, and a Z direction.

7. The digital reading glass of claim 6, wherein image registration changes in the X direction causes the display to be updated frequently.

8. The digital reading glass of claim 6, wherein image registration changes in the Y direction causes a display routine to attempt to keep lines of text where they were in a previous frame.

9. The digital reading glass of claim 6, wherein image registration changes in the Z direction causes the adjustment of magnification to maintain a substantially constant text size.

10. The digital reading glass of claim 1, wherein the display is on a front side of the camera phone and the camera is on a back side of the camera phone.

11. The digital reading glass of claim 1, wherein the camera phone further comprises a dedicated button for entering the magnifying glass mode.

12. The digital reading glass of claim 1, wherein the processor is further programmed to perform optical character recognition when displaying text.

13. The digital reading glass of claim 12, wherein the camera further comprises a speaker and the processor is further programmed to synthesize text to speech on text recognized using optical character recognition to provide an audible output.

14. The digital reading glass of claim 1, wherein the processor is programmed to use motion detection for scrolling a previously captured image.

15. A system of providing a magnifying glass function in a camera phone, comprising:
a camera;
a transceiver coupled to the camera;
a display;
an adjustable light source; and
a processor coupled to the camera, display, and light source, wherein the processor is programmed to:
selectively operate during a magnifying glass mode to have a substantially constant level of magnification regardless of focal length; and
adjust the light source to maintain a predetermined brightness level.

16. The system of claim 15, wherein the processor is programmed to provide image stabilization during the magnifying glass mode.

17. The system of claim 15, wherein the processor is programmed to track image registrations in an X direction where image registration changes in the X direction causes the display to be updated frequently, track image registrations in an Y direction where image registration changes in the Y direction causes a display routine to attempt to keep lines of text where they were in a previous frame, and track image registration in a Z direction where image registration changes in the Z direction causes the adjustment of magnification to maintain a substantially constant text size.

18. A method of providing a digital reading glass function using a camera phone, comprising the steps of:
obtaining a series of images with a camera from a camera phone; and
selectively display the series of images during a magnifying glass mode in a manner having a substantially constant level of magnification notwithstanding variations in focal length.

19. The method of claim 18, wherein the method further comprises the step of modifying a light source intensity in order to maintain a predetermined brightness level.

20. The method of claim 18, wherein the method further comprises the step of stabilizing the series of images during the magnifying glass mode.
